(19) United States
(12) Patent Application Publication
(10) Pub. No.: US 2025/0156127 A1
(43) Pub. Date: May 15, 2025

(54) COMPUTER-IMPLEMENTED METHOD FOR THE ANOMALY DETECTION

(71) Applicant: manroland Goss web systems GmbH, Augsburg (DE)

(72) Inventors: Alexander SAILER, Zusmarshausen (DE); Antonio JURIC, Neusäß (DE)

(21) Appl. No.: 18/949,536

(22) Filed: Nov. 15, 2024

(30) Foreign Application Priority Data
Nov. 15, 2023 (DE) 10 2023 131 836.5

(51) Int. Cl. G06F 3/12

(52) U.S. Cl. CPC G06F 3/121; G06F 3/1234

(57) ABSTRACT

The invention relates to a computer-implemented method for the evaluation of data, wherein the method comprises: receiving a data set from at least one component of a printing machine or a print-processing machine, wherein the data set comprises a first variable with a plurality of first data points and at least one second variable with a plurality of second data points, carrying out a computer-implemented anomaly detection of the first data points of the first variable for determining at least one anomaly. The invention is thus based on the object of finding a solution, in the case of which the anomaly detection can be applied for different production states and when using different consumables. The object is solved according to the invention in that at least the second data points of the second variable are considered during the computer-implemented anomaly detection of the first data points of the first variable.

### CROSS-REFERENCE TO RELATED APPLICATIONS

This application claims priority to German Patent Application No. 10 2023 131 836.5, filed on Nov. 15, 2023, the entire contents of which are incorporated by reference herein.

### DESCRIPTION

The invention relates to a computer-implemented method for evaluating data, wherein the method comprises: receiving a data set from at least one component of a printing machine or of a print-processing machine, wherein the data set comprises a first variable with a plurality of first data points and at least one second variable with a plurality of second data points, carrying out a computer-implemented anomaly detection of the first data points of the first variable for determining at least one anomaly.

Printing machines and print-processing machines are technically highly complex devices, in the case of which numerous functions must take place in an executable manner and so as to be adapted to one another. Substrates, such as, for example, paper webs, webs of plastic films or separated sheets are furthermore processed therewith, which, on the one hand, have different properties and which partly react in a highly sensitive manner to web tension fluctuations, for example. To create an error-free print image and/or to carry out a positionally accurate cut or fold, an extremely high precision of the components used there is required at the same time, which is why machines of this type have a highly extensive and complex control.

At the same time, there is the demand on machines of this type to also have a very high availability due to the products, which are to be produced in a time-limited manner for the most part, so that downtimes and malfunctions have to be avoided or at least minimized.

In this respect, the desire is to avoid downtimes as well as error messages, which partly lead to a machine downtime. An error message occurs when a variable determined in the machine exceeds an admissible threshold value. In fact, it is the object of the invention to avoid the development of classic error messages and to detect corresponding anomalies by means of computer-implemented analysis of relevant variables, in order to thus be able to draw conclusions early on and in a preventative manner to changes of the machine or of a component or to the behavior of the machine or of a component, even before malfunctions or error messages occur.

However, the methods known from the prior art of the anomaly detection of a variable, which is considered individually on its own, are not effective hereby in the case of a printing machine or in the case of a complex component of the graphic industry and the numerous influencing variables and relationships because individual variables can vary strongly due to different production demands, different production states, differently used printing material and aids.

The invention is thus based on the object of finding a solution, in the case of which the anomaly detection can be applied for different production states and when using different consumables.

The object is solved according to the invention in that at least the second data points of the second variable are considered during the computer-implemented anomaly detection of the first data points of the first variable.

This solution provides the advantage that the course of the first variable and thus the definition of a normal course of the first variable and what therefore represents an anomaly of this variable, is put into the context of at least one second variable of the machine. The anomaly detection of the first variable thus takes place as a function of the value and/or the change of the value of at least one second variable, wherein the second variable can also be a specific state or a specific operating type because the first variable can have a different or changed normal course in the case of a changed or changing second variable. An anomaly detection of this type according to the invention is not possible during a univariate anomaly detection because only one variable viewed by itself is analyzed there with regard to the occurrence of anomalies, so that relationships between different variables, parameters or machine states cannot be considered with this method, in particular with a computer-implemented method.

Compared to a multivariate anomaly detection, the method according to the invention further has the advantage that two or more variables do not have to be analyzed simultaneously with regard to anomalies, which, on the one hand, increases the evaluation speed and simultaneously reduces the required computing capacity, especially because the second variable, such as, for example, the fact as to whether a printing unit is in printing-on position or in a printing-off position, can only have two values without corresponding anomalies, or the second variable can assume only an unchangeable value, such as, for example, the web width of the substrate to be processed, during a production, so that the second variable can also partly have no anomaly, but the second variable can be of the utmost importance for the normal course of the first variable.

According to one design of the invention, the at least one detected anomaly of the first variable with the corresponding data point of the at least second variable is displayed and/or saved and/or electronically documented or stored in any other way.

This design has the advantage and the special feature that an assessment of the anomalies of the first variable, for example with respect to the extent, frequency and the course thereof, is possible in the context of at least the second variable. Operating states or machine states can thus be considered with respect to their effects on the occurrence of anomalies of the first variable.

According to a further design of the invention, the temporal course of the first variable before and/or after a detected anomaly and the temporal course of the second variable before and/or after a detected anomaly is represented and/or saved and/or electronically documented or stored in any other way.

This design has the advantage that a temporal relationship in the event of a change of the second variable and the anomalous behavior of the first variable resulting therefrom can be analyzed and evaluated therewith. It is further possible thereby that the temporal change and temporal relationships in the event of the change of the second variable and the influencing of the first variable can be analyzed in an automated manner therewith in order to reduce waste, which may result therefrom.

According to a further advantageous design of the invention, the at least one anomaly of the first variable is characterized as error message when it exceeds a predetermined threshold value.

This design provides the advantage that only the anomalies of the first variable, which assume a significant level and thus either already cause malfunctions or can at least cause malfunctions of the production, can be filtered out and evaluated therewith. The resulting data quantity and the capacity for a detailed evaluation is thus lowered significantly.

Preferred further developments of the invention follow from the subclaims and the following description. Different exemplary embodiments of the invention are described in more detail on the basis of the drawings, without being limited thereto, wherein

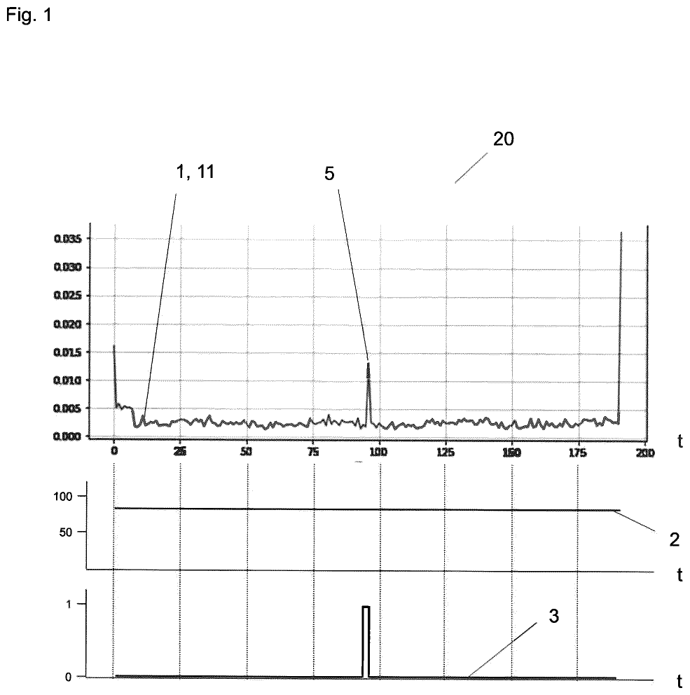

FIG. 1 shows an exemplary data set with a first, second and third variable

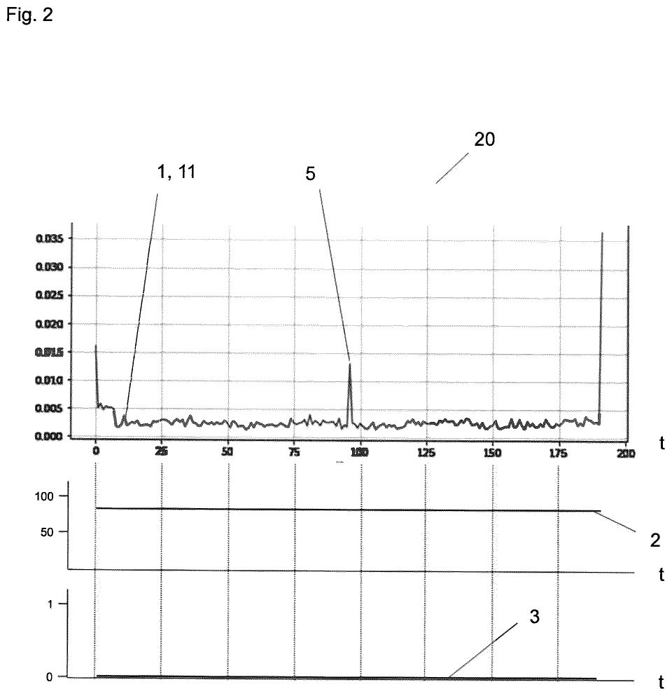

FIG. 2 shows an exemplary data set with a first, second and third variable

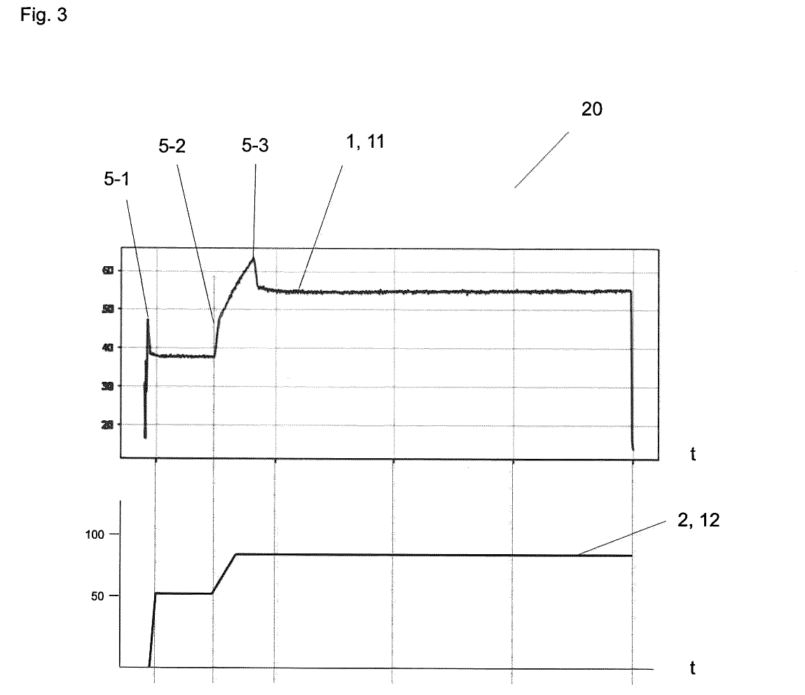

FIG. 3 shows an exemplary data set with a first and second variable

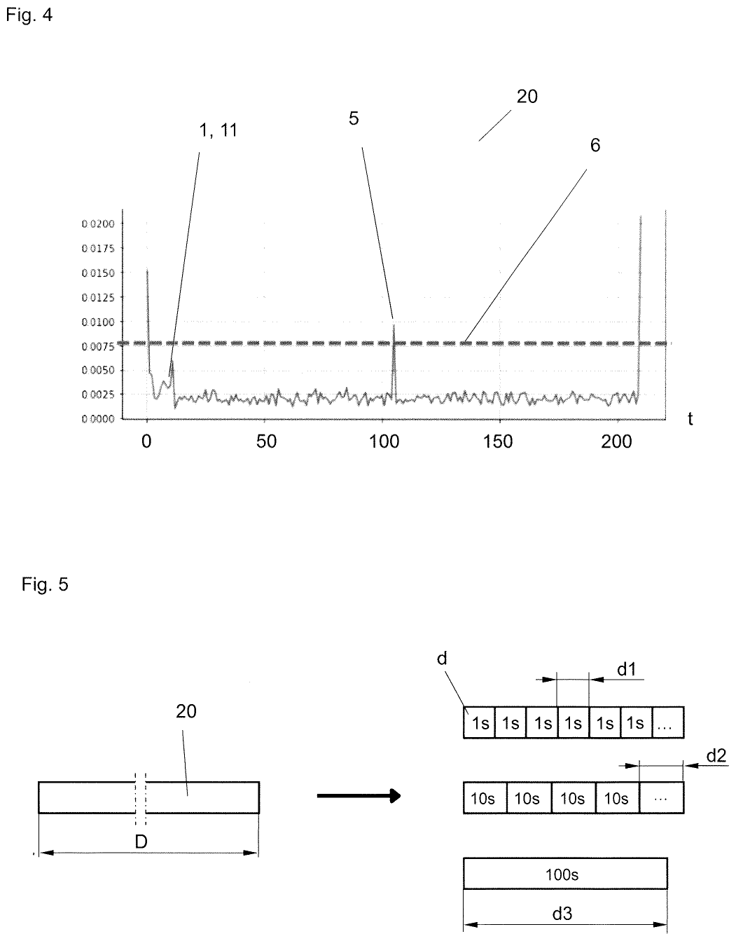

FIG. 4 shows an anomaly detection with a threshold value

FIG. 5 shows a temporal distribution of a data set

Numerous sensors are used on a printing machine or a machine of the graphic industry and/or the already existing variables, such as power consumption of the motors, the rotational speed of the motors, torques of the motors, the web tension, web courses in or perpendicular to the transport direction, the color density, the register accuracy of the print image and many further variables are detected or determined.

However, the variables detected or determined hereby do not always run statically at their nominal value constant over time, but the data set of each variable detected or determined in this way comprises a plurality of data points, wherein the determined variables often have a certain fluctuation and thus a certain scattering by their nominal value.

FIG. 1 shows the course of a first variable 1 of this type using the example of a drive torque of a printing unit drive motor over time. For each time unit, a defined number of first data points 11 are detected or determined hereby and are plotted over time, so that with these data points 11, the temporal course of this first variable 1, for example the drive torque, can be determined, saved, recorded or graphically illustrated, for example. As can be seen from FIG. 1, this first variable assumes a first average actual value, by which this first variable 1 fluctuates.

However, larger deviations from this average actual value, which are referred to as anomaly 5 of this first variable 1, occur at mostly irregular intervals. An anomaly 5 of this type can have different causes and is a function of the deviation attained thereby from the average actual value even without impacts on an error-free and permanent operation of the system.

However, in the case of more frequent and stronger anomalies 5 of a first variable 1, conclusions can be drawn to, for example, the maintenance state or the attained service life, which is why the detection of anomalies 5 of this type is significant for the preventative maintenance and thus for an error-free operation of the system.

However, first data points 11 of this type and the course of the first variable 1 determined thereby are mostly only of limited significance, unless at least one second variable 2 is considered when considering the first variable 1 and the detection of anomalies 5 of the first variable 1. The detection of anomalies 5 of the first variable 1, precisely this first variable 1 is thus put into context with at least one second variable 2.

FIG. 1 thus shows a data set 20, which, as first variable 1, comprises, for example, the drive torque of a printing unit and simultaneously as second variable 2, comprises the relative target web speed and, as third variable 3, the control signal for a roll changer.

Due to the fact that the target web speed as second variable 2 assumes a constant value in the case of the example illustrated in FIG. 1, the second variable 2 is constant over time. Due to the fact that a roll change is required during the production because the expiring substrate roll has reached the minimum diameter and the initiation of a roll changer process is required, the third variable 3 in the first half of the recorded production is at zero and the third variable 3 assumes the value of one only at the time of the roll change.

As can be seen in the example illustrated in an exemplary manner in FIG. 1, the analysis and detection of anomalies 5 of the first variable 1 would not be as significant without the reference of the first variable 1 in particular to the third variable 3 because wrong conclusions to the mode of operation or the maintenance state of the drive motor might possibly be drawn in the case of purely isolated anomaly detection of the first variable 1.

To clarify the advantage of the invention, FIG. 2 shows the example from FIG. 1, according to which the first variable 1 is analyzed over a defined time period with respect to the occurrence of anomalies 5 and wherein the data set 20 simultaneously contains the relative target web speed as second variable 2 and the control signal for a roll changer as third variable 3.

This example shows the case that at the time of the occurrence of the anomaly 5 of the first variable 1, the second variable 2 is still constant due to a non-changed target web speed and wherein at the time of the occurrence of the anomaly 5 of the first variable 1, the third variable 3 is also zero, so that no roll changing was triggered.

From a technical perspective, the case illustrated in FIG. 2 is to thus be assessed completely differently than the example illustrated in FIG. 1. This is so because in the case of the example illustrated in FIG. 1, the anomaly 5 of the first variable 1, namely for example of the drive torque of a printing unit drive is to be seen in context and thus as consequence of a roll change, in order to either correct the web tension at very short notice again, or the torque peak of the anomaly 5 can be the result of passing through the adhesive point, which is thickened compared to the remaining substrate web. However, no change of the second variable 2 detected in addition to the first variable 1 and third variable 3 can be detected in the case of the example illustrated in FIG. 2, which is why the example illustrated in FIG. 2 is a technically unfounded anomaly 5, which can thus be used to evaluate the state of the drive regulator or of the drive motor.

The examples illustrated in FIG. 1 and FIG. 2 also show the advantage of the present invention compared to a univariate anomaly detection because in the case of a univariate anomaly detection, only the first variable 1 would be considered by itself and would be assessed and no statement would thus be possible as to whether the determined anomaly 5 is not in fact the result of a defined cause.

According to general definition, a multivariate anomaly detection would detect neither the case represented in FIG. 1 nor the case represented in in an exemplary manner in FIG. 2 as potential anomaly. In the case of the example illustrated in FIG. 1, an anomaly 5 in terms of an anomalous behavior compared to the remaining observation time only occurs in the case of the first variable 1 but not in the case of the second variable 2 because the latter is constant, and also not in the case of the third variable 3 because the command for the roll change is not an anomaly 5 but a regular signal of the machine control. The anomaly 5 illustrated in FIG. 1 can thus not be detected with a multivariate anomaly detection.

The case illustrated in FIG. 2 can also not be detected as anomaly 5 with a multivariate anomaly detection because the anomaly 5 occurs only in the case of the first variable 1 but in fact not in temporal relationship with an anomaly of the second variable 2 and of the third variable 3.

The method according to the invention provides for an automatic detection of actual anomalies 5, that is, of anomalous courses of the first variable 1, which are not the result of a known interference variable, such as, for example, a roll changer, because technically justifiable fluctuations of this type of the first variable are filtered out.

It is further possible to design the method to be trainable by using artificial intelligence, so that, for example, not only changes, which temporally relate directly to the anomaly 5, of at least one second variable 2, but also changes, which are temporally spaced apart from the anomaly 5 within certain limits, of at least one second variable 2, such as, for example, of the third variable 3 in the example of FIGS. 1 and 2, can be filtered as cause of an anomalous behavior of the first variable 1.

It is thus possible to represent, display, save or document accordingly, preferably electronically, the at least one detected anomaly 5 of the first variable 1 with the one or the plurality of corresponding data points 12 of the second variable 2.

It is thus further also possible to represent, display, save or accordingly document, preferably electronically, the temporal course of the first variable 1 before and/or after a detected anomaly 5 and the temporal course of at least the second variable 2 before and/or after a detected anomaly 5.

FIG. 3 shows an exemplary data set 20, which has plotted first data points 11 of a first variable 1 over time, wherein the first variable 1 displays of the power consumption of a drive motor of a printing unit. The data set 20 further comprises the second data points 12 of a second variable 2 plotted over time, wherein the second variable corresponds to the target web tension.

For the first variable 1, an anomaly detection for detecting the anomalies 5 occurring there takes place by means of a computer-implemented method. Several anomalies 5 are hereby determined by the system. The first anomaly 5-1 does not last very long and possibly represents an overshooting of the drive. The power consumption remains stable after the first anomaly 5-1.

After a dwell time, a second anomaly 5-2 is detected, namely a sudden steep increase of the power consumption as first variable 1, wherein an increase of the first variable 1 takes place after this second anomaly 5-2.

After the increase, a third anomaly 5-3 in the form of a peak power of the first variable 1 is detected, an essentially static course of the first variable 1 takes place after this third anomaly 5-3.

In the case of autarkic anomaly detection, as it is known from the prior art, it would not make much sense both for a computer-implemented method for assessing the first anomaly 5-1, the second anomaly 5-2 and the third anomaly 5-3, the assessment and evaluation of these anomalies 5-1, 5-2 and 5-3 by a computer-implemented method or even by a person of skill in the art on its own would likewise not be effective.

Due to the consultation of the web tension according to the invention as second variable 2, but without likewise carrying out an anomaly detection for this second variable, it is possible for a computer-implemented evaluation method as well as for a person of skill in the art to assess these anomalies 5-1, 5-2 and 5-3 accordingly and to draw the correct conclusion therefrom.

FIG. 4 shows the upper section of FIGS. 1 and 2, namely the temporal course of the data points 11 of the first variable 1 with an anomaly 5, which occurred therein.

To avoid that even though first data points 11 of the first variable with anomalous value and/or course are detected as relevant anomaly 5 compared to the plurality of the first data points 11 of the first variable 1, an anomalous course of the first variable 1 can only be characterized as anomaly 5 and can thus be detected or documented or saved or represented as such when it exceeds a predetermined threshold value 6.

It is thus possible that smaller deviations of the first variable 1 from the normal behavior are not defined as anomaly 5 in the literal sense, so as thus not to distort the evaluations by means of usual fluctuations, measuring tolerances or by means of a noise in the data transmission.

In one design of the invention, an analysis data set can be generated with the at least one anomaly 5 detected in this way together with the corresponding first variable 1 and at least the second variable 2. It is irrelevant hereby whether the detected anomalies 5 are filtered according to the above-specified designs and whether they include only the first data points 11 of the first variable 1 and only the relevant data points 12 of at least the second variable 2 at the time of the occurrence of the anomaly 5 or whether the course of the first variable 1 and at least of the second variable 2 before and/or after a detected anomaly 5 are included.

An analysis data set can either be assigned to an entire machine or only to a component, so that a documentation of the anomalies 5, which occurred at this machine or component, is possible for any given time period. The behavior of this machine or of this component with respect to the anomalies 5 can thus be analyzed for any given time period, in order to be able to draw conclusions about preventative maintenance operations, for example.

An AI-based software module, such as, for example, a dense autoencoder or an LSTM autoencoder or an isolation forest can be used for the anomaly detection of the first variable 1. Software of this type is known as prior art and is available from various suppliers, so that only the relationship with the at least second variable 2 is to be integrated programmatically.

FIG. 5 shows in example, according to which a data set 20 with a certain time period D illustrated in an exemplary manner on the left side is divided into a plurality of time intervals d for the anomaly detection.

It is possible hereby to divide the data set 20 with the time period D into time interval d of a first time period d1 and/or of a second time period d2 and/or of a third time period d3. In the case of a suitable selection of the first time period d1, of the second time period d2 and of the third time period d3 of the time intervals d, it is hereby to detect different anomaly types.

In the case of a short first time period d1, such as, for example, 1 to 50 seconds, preferably 1 to 10 seconds, global anomalies 5 can be detected, for example.

If the time interval d is extended, such as, for example, in the case of a second time period d2, such as, for example, 10 to 1000 seconds or 10 to 100 seconds, contextual anomalies 5 can be better detected because they can be detected only in a larger temporal relationship.

If the time interval d is extended once again, such as, for example, in the case of a third time period d1, such as, for example 10 to 10 000 seconds or 10 to 1000 seconds or the entire duration of a production, collective anomalies 5 can be detected. In the case of a collective anomaly of this type, individual data points are not noticeable, the collective anomaly 5 can often be detected only in the overall context.

It goes without saying that the above-specified anomaly types can thus also be carried out simultaneously or one after the other for one and the same data set.

The time intervals d can also be determined in a different variable than the time or the time period, respectively. Alternatively to a time period, can have for example a certain number of revolutions of the printing cylinders or of the impulses of the drive regulation or a certain number of data points for the time intervals d, as a function of the trigger rate of the data collection.

It is thus possible, for example, that the time intervals d have a first number n1 and/or a second number n2 and/or a third number n3 of first data points.

The first variable 1 and/or at least the second variable 2 as well as any further detected variable can either be detected by means of sensors, such as, for example, voltages or currents, or can be calculated, such as, for example, the torque of an electric drive motor, which is derived from the relevant electrical characteristic variables of the drive motor.

For example, a drive torque of a motor or a power consumption of a motor or a rotational speed of a motor or a web tension of a substrate to be processed or a lateral course of a substrate to be processed or a register deviation can be used as first variable 1.

For example, a production speed or a printing-on position of a printing cylinder or a maintenance process, such as the blanket washing or an activity of a roll changer or an activity of a downstream aggregate can be used as second variable 2.

### LIST OF REFERENCE NUMERALS

1 first variable
2 second variable
3 third variable
5 anomaly
6 threshold value
11 first data points
12 second data points
20 data set
D time period
d time interval

1. A computer-implemented method for the evaluation of data, wherein the method comprises:
receiving a data set from at least one component of a printing machine or a print-processing machine, wherein the data set comprises a first variable with a plurality of first data points and at least one second variable with a plurality of second data points, carrying out a computer-implemented anomaly detection of the first data points of the first variable for determining at least one anomaly, characterized in that at least the second data points of the second variable are considered during the computer-implemented anomaly detection of the first data points of the first variable.

2. The method according to claim 1, characterized in that the at least one anomaly of the first variable with the corresponding data point of the at least second variable is displayed.

3. The method according to claim 1, characterized in that the temporal course of the first variable before and/or after a detected anomaly and the temporal course of at least the second variable before and/or after a detected anomaly is represented.

4. The method according to claim 1, characterized in that the at least one anomaly of the first variable is characterized as error message when it exceeds a predetermined threshold value.

5. The method according to claim 1, characterized in that an analysis data set with the first variable and the at least second variable) is generated for the at least one detected anomaly.

6. The method according to claim 1, characterized in that an AI-based software module is used for the anomaly detection.

7. The method according to claim 6, characterized in that an AI-based software module an autoencoder, such as, for example, a dense autoencoder or an LSTM autoencoder or an isolation forest is used.

8. The method according to claim 1, characterized in that for the anomaly detection, the data set is divided into a plurality of time intervals d.

9. The method according to claim 8, characterized in that the time intervals d have a first time period d1 and/or a second time period d2 and/or a third time period d3.

10. The method according to claim 8, characterized in that the time intervals d have a first number n1 and/or a second number n2 and/or a third number n3 of first data points.

11. The method according to claim 1, characterized in that the first variable and/or the at least second variable are determined by means of sensors or are calculated.

12. The method according to claim 1, characterized in that a drive torque of a motor or a power consumption of a motor or a rotational speed of a motor or a web tension of a substrate to be processed or a lateral course of a substrate to be processed or a register deviation is used as first variable.

13. The method according to claim 1, characterized in that a production speed or a printing-on position of a printing cylinder or a maintenance process, such as the blanket washing or an activity of a roll changer or an activity of a downstream aggregate is used as second variable.
